(19) United States
(12) Patent Application Publication
(10) Pub. No.: US 2010/0058230 A1
(43) Pub. Date: Mar. 4, 2010

(54) SYSTEM OF AUTOMATIC WINDOW ADJUSTMENT AND METHOD THEREOF

(76) Inventor: Honda SHING, San Mateo, CA (US)

Correspondence Address: EGBERT LAW OFFICES, 412 MAIN STREET, 7TH FLOOR, HOUSTON, TX, 77002, US

(21) Appl. No.: 12/546,619

(22) Filed: Aug. 24, 2009

Related U.S. Application Data
(60) Provisional application No. 61/092,663, filed on Aug. 28, 2008.

(51) Int. Cl. G06F 3/048

(52) U.S. Cl. 715/788

(57) ABSTRACT

The present invention discloses a system of automatic window adjustment and a method thereof in order to resolve the problems concerning blockage of a critical window during the use of window interface. The system of automatic window adjustment is applicable to the electronic devices equipped with a window-based operating system, including a window, a message reception unit, an adjustment determination unit and a calculation unit. The message reception unit is arranged to receive a message issued by the operating system. The adjustment determination unit determines whether the window adjustment is required based on the message and the current status of windows, and generates an adjustment determination result. In case the adjustment determination result indicates the adjustment is required, the calculation unit calculates the dynamic adjustment parameter according to the current status of windows, and performs adjustments of the window based on the dynamic adjustment parameter.

### RELATED U.S. APPLICATIONS

The present application claims priority from U.S. Provisional Patent Application Ser. No. 61/092,663, filed on Aug. 28, 2008 and entitled “METHOD FOR DYNAMICALLY EXPOSING SELECTED OBJECTS IN A WINDOWS ENVIRONMENT.”

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention generally relates to a graphical user interface. In particular, the present invention relates to a window display system for performing automatic adjustment of windows and a method thereof.

2. Description of Related Art Including Information Disclosed Under 37 CFR 1.97 and 37 CFR 1.98

At present, the window-based environment has been widely applied in many computer systems, e.g., WINDOWS™ operating system from MICROSOFT (TM) on personal computers and MAC OS™ for APPLE™ computers, to name a few. The aforementioned window-based operating systems provide user-friendly graphic operation interfaces, thereby enabling management of multiple programs running thereon and interactions with computer systems within a display screen of limited size.

In operation, multiple windows can be fully or partially displayed on the screen at the same time, but among them there is usually only one window being active or acquiring the input focus. Since multiple windows are shown within the screen of limited size, thus except the active one, other windows are inevitably blocked partially or completely due to the arrangement of such windows. A blocked window cannot be fully displayed until it is set to be active and acquires the input focus or until the events that the blocking window is moved away or closed and so forth occur.

The above-said operation may cause some inconveniences in use, especially when a certain window displays an important message that requires the user's immediate attention, thus the user may preferably hope that such a critical window can be kept unblocked even though it may not be active or with the input focus. Furthermore, when a user works over a certain window shown on the screen, it is usually necessary to open another specific window to display reference data therein. At this moment, such a specific window should not be blocked by other windows, even it is not active. For example, when a user writes a document and simultaneously needs to make reference to other documents, the user fills a form and has to use a calculator program to perform data calculation, or alternatively works and at the same time runs video player program to play a movie. During the process, the user may wish the above-referred documents, the calculator program window and the video player window not to be blocked by other windows.

In dealing with the aforementioned window blocking issue, the user may manually adjust the position and size of the window, such that the window is not blocked. However, in a currently available window environment, to solve the window blockage problem described as above, an “Always on the Top” design is provided in which a window is shown on the top all the time and never blocked by other windows, or it may even block the active one. Although such an approach can prevent critical windows from being blocked by other windows, it may cause more inconvenience in operations because the active window could be thus blocked.

Furthermore, upon occurrences of window change actions such as window open, window close, window move, window resize, window active and window inactive and so on, as well as events like screen resolution change and screen available space change etc., the operating system generates corresponding messages and sends them to the running applications. The aforementioned actions can cause dynamic changes in terms of available areas on the screen. In prior art, the “Always on the Top” design does not handle the above-said issue of dynamic changes of available areas.

Therefore, in view of such drawbacks found in prior art, the inventor of the present application proposes a system of automatic window adjustment and a method thereof as solutions. Automatic adjustments are performed in accordance with window status upon occurrence of said blockage, thereby enabling implementation and basis for eliminating the drawbacks illustrated hereinbefore.

### BRIEF SUMMARY OF THE INVENTION

With regard to the drawbacks in the prior art, the objective of the present invention is to provide a system of automatic window adjustment and a method thereof which enables automatic window adjustment according to the window status when the user of a window-based operating system performs window operations, thereby minimizing blockage to the critical window by other windows.

According to another objective of the present invention, a system of automatic window adjustment and a method thereof is provided which, when a user is operating an active window, simultaneously allows related reference windows to be completely or mostly displayed on the screen and to be automatically adjusted based on the window status so that blockage by other windows can be minimized.

To achieve the objectives set forth as above, the present invention provides a system of automatic window adjustment applicable to electronic devices running a window-based operating system. Such an operating system generates messages according to user operations and stores status of all windows therein. The system comprises a window, a message reception unit, an adjustment determination unit and a calculation unit. The message reception unit is arranged to receive messages issued by the operating system. The adjustment determination unit determines whether a window adjustment is required based on each message and the current status of windows, and generates an adjustment determination result. In case the adjustment determination result indicates the adjustment is required, the calculation unit calculates a dynamic adjustment parameter in accordance with the current status of windows, and performs window adjustment based on the dynamic adjustment parameter.

The adjustment determination unit determines whether the window is blocked based on the current status of windows; if yes, i.e. blocked, then the adjustment determination result indicates the adjustment is required. Besides, the adjustment determination unit further determines whether additional space is available for use by the window based on the current status of windows.

The present invention may further comprise a squeeze adjustment unit, which generates a squeeze adjustment parameter based on the current status of windows, and accordingly moves or resizes other windows so as to acquire more space for accommodating the window.

The present invention may further comprise a setting unit, which allows setting the window as an automatically adjusted window.

The setting unit is further allowed to set a profile, and the window is automatically selected as an automatically adjusted window when it matches the profile.

The present invention may further comprise a mode parameter, which can be arranged to set the adjustment mode, thereby performing adjustments according to the mode parameter during window adjustment. The mode parameter may be the immediate adjustment mode, the deferred adjustment mode or the notification mode. The immediate adjustment mode causes immediate adjustment in accordance with the dynamic adjustment parameter. The deferred adjustment mode starts the adjustment based on the dynamic adjustment parameter only when a certain trigger condition, such as the window receives a new message or important contents change in the window etc., is satisfied. The notification mode allows an adjustment notification to be issued, and the notified application itself is responsible for deciding whether or how to perform adjustment.

The message may be a window change message, and the window change message may be a window open message, a window close message, a window move message, a window resize message, a window active status change message, a screen resolution change message, a window hide message, a window show message or a screen available space change message and the like.

Additionally, the present invention further provides a system of automatic window adjustment, which is applicable to a window-based operating system. Such a window-based operating system generates a dynamic adjustment parameter based on the current status of windows. The system comprises a window, a reception unit and an adjustment unit. The reception unit receives a dynamic adjustment parameter. The adjustment unit performs an adjustment of the window, adjustments of other windows, or adjustments of both the window and other windows based on the dynamic adjustment parameter.

The present invention may further comprise a request unit, which requests the window-based operating system to issue the dynamic adjustment parameter upon reception of an adjustment notification at the reception unit.

The present invention may further comprise a registry unit, which is arranged to register the window as an automatically adjusted window.

The present invention may further comprise a mode parameter, which can be arranged to set the adjustment mode, thereby performing adjustment according to the mode parameter during window adjustment. The mode parameter may be the immediate adjustment mode, the deferred adjustment mode or the notification mode. The immediate adjustment mode causes immediate adjustment in accordance with the dynamic adjustment parameter. The deferred adjustment mode starts the adjustment based on the dynamic adjustment parameter only when a certain trigger condition, such as the window receives a new message or important contents change in the window etc., is satisfied. The notification mode allows an adjustment notification to be issued, and the notified application itself is responsible for deciding whether or how to perform adjustment.

Furthermore, the present invention also provides a method of automatic window adjustment, which is applicable to a window-based operating system. Such an operating system generates messages according to user operations and stores status of all windows. The method comprises the following steps: initially, receiving a message issued by the operating system; next, based on the message and the current status of windows, determining whether window adjustment is required; then, if determined as yes, i.e., required, calculating a dynamic adjustment parameter in accordance with the current status of windows; finally, performing window adjustment based on the dynamic adjustment parameter.

The step of determining whether window adjustment is required comprises the following steps: determining whether the window is blocked based on the current status of windows. If the window is blocked, then the adjustment is required. Besides, it further determines whether additional space is available for use by the window in accordance with the current status of windows.

The present invention may further comprise the following steps: initially, generating a squeeze adjustment parameter based on the current status of windows; next, moving or resizing other windows based on the squeeze adjustment parameter so as to acquire more space to accommodate the window.

The present invention may further comprise the step of setting the window as an automatically adjusted window.

The present invention may further comprise the step of setting a profile, and the window is automatically selected as an automatically adjusted window when it matches the profile.

The present invention may further comprise the following steps: setting a mode parameter which can be arranged to set the adjustment mode, thereby performing adjustment according to the mode parameter during window adjustment. The mode parameter may be the immediate adjustment mode, the deferred adjustment mode or the notification mode. The immediate adjustment mode causes immediate adjustment in accordance with the dynamic adjustment parameter. The deferred adjustment mode starts the adjustment based on the dynamic adjustment parameter only when a certain trigger condition, such as the window receives a new message or important contents change in the window etc., is satisfied. The notification mode allows an adjustment notification to be issued, and the notified application itself is responsible for deciding whether or how to perform adjustment.

The message may be a window change message, and the window change message may be a window open message, a window close message, a window move message, a window resize message, a window active status change message, a screen resolution change message, a window hide message, a window show message or a screen available space change message and the like.

Additionally, the present invention further provides a method of automatic window adjustment, which is applicable to a window-based operating system. Such a window-based operating system generates a dynamic adjustment parameter based on the current status of windows. The method comprises the following steps: initially, receiving a dynamic adjustment parameter; next, performing an adjustment of a window, adjustments of other windows or adjustments of both the window and other windows based on the dynamic adjustment parameter.

The present invention may further comprise the following steps: initially, receiving an adjustment notification issued by the window-based operating system; and next, requesting the window-based operating system to issue the dynamic adjustment parameter.

The present invention may further comprise a step of registering the window as an automatically adjusted window.

The present invention may further comprise a mode parameter, which can be arranged to set the adjustment mode, thereby performing adjustment according to the mode parameter during window adjustment. The mode parameter may be the immediate adjustment mode, the deferred adjustment mode or the notification mode. The immediate adjustment mode causes immediate adjustment in accordance with the dynamic adjustment parameter. The deferred adjustment mode starts the adjustment based on the dynamic adjustment parameter only when a certain trigger condition, such as the window receives a new message or important contents change in the window etc., is satisfied. The notification mode allows an adjustment notification to be issued, and the notified application itself is responsible for deciding whether or how to perform adjustment.

In summary of the descriptions set forth hereinbefore, the system of automatic window adjustment and the method thereof according to the present invention may provide at least one of the following advantages:

First, the system and the method thereof according to the present invention allows the operating system or applications to manage the arrangement of multiple windows, or the user is allowed to set a certain critical window or relevant reference windows as automatically adjusted windows during window operations, such that they are not blocked or less blocked by other windows, thereby improving convenience in operations.

Second, the system and the method thereof according to the present invention allows the operating system or application to manage the arrangement of multiple windows, or it is possible to determine whether additional space exists on the screen during user's window operations, thereby using the additional space for adjusting the automatically adjusted window. Also, rearrangement or resizing on excessive windows shown on the screen can be achieved through squeeze adjustment, thus acquiring more space for use.

Third, the system and the method thereof according to the present invention provides the mode parameter, thereby facilitating the operating system or application to manage the arrangement of multiple windows, or alternatively during user's window operations, it is possible to optionally swap to the required mode based on different demands. In case the determined automatically adjusted window needs to be adjusted immediately, the immediate adjustment mode can be selected. Supposing immediate adjustment is not required in the determined automatically adjusted window, the deferred adjustment mode can be a preferred choice. In this way, by switching the mode parameter, different user demands can be suitably satisfied, enabling more flexible use of the window interface.

To enable better appreciation of the system of automatic window adjustment and the method thereof according to the present invention, references will now be made to the detailed descriptions hereinafter, in conjunction with the appended drawings.

### BRIEF DESCRIPTION OF THE SEVERAL VIEWS OF THE DRAWINGS

FIG. 1 is a schematic view of a diagram of the system of automatic window adjustment according to the present invention.

FIG. 2 is a flowchart of the method of automatic window adjustment according to the present invention.

FIG. 3A to 3F are the schematic views of diagrams showing the first embodiment of the system of automatic window adjustment and the method thereof according to the present invention.

FIG. 4A to 4B are schematic views of the diagrams showing the second embodiment of the system of automatic window adjustment and the method thereof according to the present invention.

FIG. 5A to 5C are schematic views of the diagrams showing the third embodiment of the system of automatic window adjustment and the method thereof according to the present invention.

FIG. 6A to 6C are schematic views of the diagrams showing the fourth embodiment of the system of automatic window adjustment and the method thereof according to the present invention.

FIG. 7A to 7E are schematic views of the diagrams showing the fifth embodiment of the system of automatic window adjustment and the method thereof according to the present invention.

FIG. 8 is a schematic view of the diagram of the system of automatic window adjustment according to the present invention.

FIG. 9 is a flowchart of the method of automatic window adjustment according to the present invention.

### DETAILED DESCRIPTION OF THE INVENTION

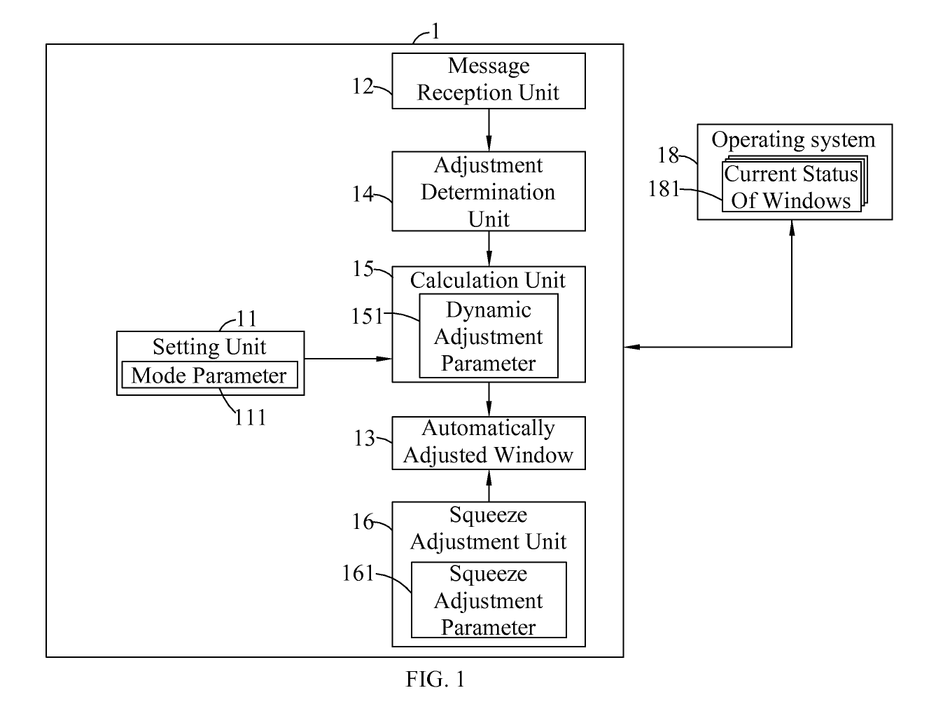

Referring now to FIG. 1, wherein a diagram of the system of automatic window adjustment according to the present invention is shown. In the Figure, the operating system 18 stores the current status of all windows 181 therein, and may generate messages based on user operation. The system of automatic window adjustment, labeled as 1, comprises a setting unit 11, a message reception unit 12, an automatically adjusted window 13, an adjustment determination unit 14, a calculation unit 15 and a squeeze adjustment unit 16.

The setting unit 11 is arranged to set the window as the automatically adjusted window 13. The setting unit 11 can also set a profile, and the window will be automatically selected as the automatically adjusted window when it matches the profile. Consequently, the user is allowed to specify automatic selection of relevant types of windows by means of such profile matching. The profile can be defined with keywords entered by the user, and then the setting unit 11 selects the window according to the defined profile. Upon opening the window that matches the profile, the opening window will be automatically selected as the automatically adjusted window. For example, when the user inputs a keyword “WORD”, the setting unit generates a profile based on such a keyword, and performs window selections on all windows of “WORD”. When the user inputs a keyword “IE”, the setting unit 11 generates a profile based on such a keyword, and performs window selections on all windows of “IE” web pages.

The message reception unit 12 is arranged to receive messages issued by the operating system 18. The automatically adjusted window 13 can be adjusted based on the dynamic adjustment parameter 151 so as to prevent from being blocked by other windows. To become the automatically adjusted window 13, it is possible either through calling a relevant program code after opening the window, or by setting the window as the automatically adjusted window 13 via the setting unit 11. The adjustment determination unit 14 determines whether window adjustment is required in the automatically adjusted window 13 according to the received message and the current status of windows 181 held in the operating system 18. In case the adjustment determination unit 14 determines that the adjustment is required, the calculation unit 15 calculates the dynamic adjustment parameter 151 in accordance with the current status of windows 181 in order to perform window adjustment. In the adjustment determination unit 14, it is possible to determine whether the automatically adjusted window 13 is blocked based on the current status of windows 181. The adjustment determination unit 14 can further determine whether additional space is available for use by the automatically adjusted window 13 based on the current status of windows 181.

The squeeze adjustment unit 16 can move or resize other windows based on the current status of windows 181 so as to acquire more space for accommodating the automatically adjusted window 13. The setting unit 11 further comprises the mode parameter 111 for setting the adjustment mode, and the mode parameter 111 can be the immediate adjustment mode, the deferred adjustment mode or the notification mode. The immediate adjustment mode causes immediate adjustment in accordance with the dynamic adjustment parameter 151. The deferred adjustment mode starts the adjustment based on the dynamic adjustment parameter 151 only when a certain trigger condition, such as the window receives a new message or important contents change in the window etc., is satisfied. The notification mode allows the dynamic adjustment parameter 151 to be transferred and an adjustment notification to be issued, while the notified application itself is responsible for deciding whether or how to perform adjustment.

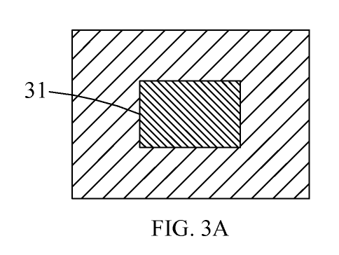

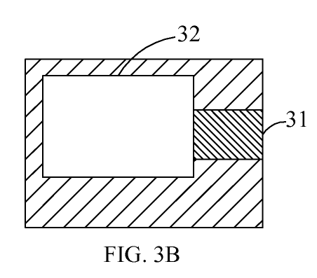

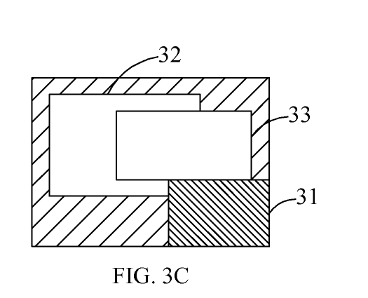

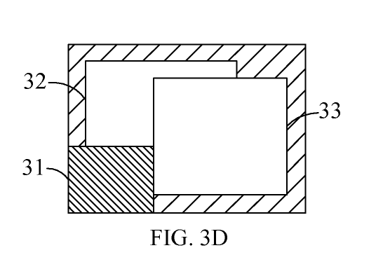

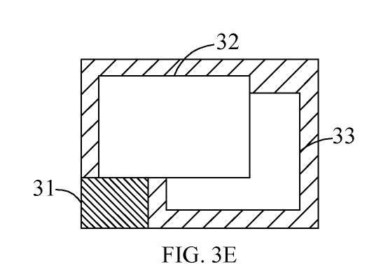

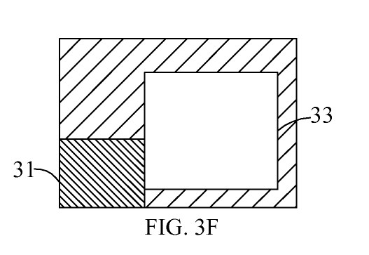

During opening, resizing or setting active a window, the automatically adjusted window may be blocked. At this moment, the system according to the present invention performs operations for window adjustment. Referring now to FIG. 3, wherein a diagram showing the first embodiment of the system of automatic window adjustment and the method thereof according to the present invention is depicted. In the descriptions as below, FIG. 3 will be referred to illustrate the system of automatic window adjustment of the present invention.

In FIG. 3A, the setting unit 11 sets the first window 31 as the automatically adjusted window 13. The message reception unit 12 receives messages issued from the operating system 18.

In FIG. 3B, the second window 32 is opened. At this moment, the message reception unit 12 receives a window change message issued from the operating system 18. Subsequently, the adjustment determination unit 14 determines that the first window 31 is blocked based on the window change message and the current status of windows 181 in the operating system 18. Next, the calculation unit 15 calculates and obtains the dynamic adjustment parameter 151 based on the current status of windows 181 and performs accordingly the adjustment of the first window 31.

In FIG. 3C, the third window 33 is opened. At this moment, the message reception unit 12 receives a window change message sent by the operating system 18. Following this, the adjustment determination unit 14 determines that the first window 31 is blocked based on the window change message and the current status of windows 181 in the operating system 18. Then, the calculation unit 15 provides the dynamic adjustment parameter 151 based on the window status parameter 181 and performs accordingly the adjustment of the first window 31.

In FIG. 3D, the third window 33 is resized. Now the message reception unit 12 receives a window change message coming from the operating system 18. Next, the adjustment determination unit 14 determines that the first window 31 is blocked based on the window change message and the current status of windows 181 in the operating system 18. Then, the calculation unit 15 calculates the dynamic adjustment parameter 151 based on the current status of windows 181 and performs accordingly the adjustment of the first window 31.

In FIG. 3E, the second window 32 is set to be active. In this case, the message reception unit 12 receives a window change message sent by the operating system 18. Subsequently, the adjustment determination unit 14 determines that the first window 31 is blocked based on the window change message and the current status of windows 181 in the operating system 18. Then, the calculation unit 15 evaluates the dynamic adjustment parameter 151 based on the window status parameter 181 and performs accordingly the adjustment of the first window 31.

Upon closing the window, additional space may be generated for use by the automatically adjusted window 13. In such a case, the system according to the present invention can perform relevant window adjustment. Referring now to FIG. 3F, wherein the second window 32 is closed, meanwhile the message reception unit 12 receives a window change message from the operating system 18. Next, the adjustment determination unit 14 determines that the first window 31 is not blocked based on the window change message and the current status of windows 181 in the operating system 18. At this time, the adjustment determination unit further determines that there exists additional space available for use based on the current status of windows 181. Then, the calculation unit 15 calculates and obtains the dynamic adjustment parameter 151 based on the current status of windows 181 and performs accordingly the adjustment of the first window 31.

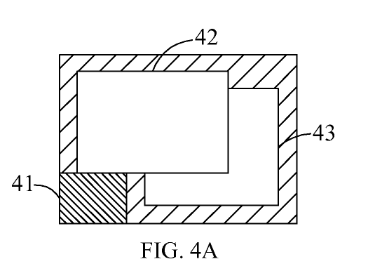

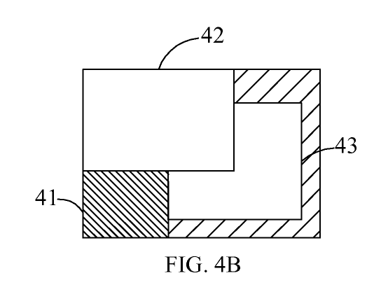

As the window is moved or reduced in size, additional space may be generated for use by the automatically adjusted window 13. At this moment, the system according to the present invention can perform relevant window adjustment. Referring now to FIG. 4, wherein a diagram showing the second embodiment of the system of automatic window adjustment and the method thereof according to the present invention is depicted. Hereinafter FIG. 4 will be taken as an example for illustrating the system of automatic window adjustment according to the present invention.

In FIG. 4A, the first window 41 is the automatically adjusted window 13, the second window 42 is the active window, and the third window 43 is blocked by the second window 42. The message reception unit 12 receives messages from the operating system 18.

In FIG. 4B, the second window 42 is moved to the upper left corner. Now the message reception unit 12 receives a window change message sent by the operating system 18. Following this, the adjustment determination unit 14 determines that the first window 41 is not blocked based on the window change message and the current status of windows 181 in the operating system 18. At this time, the adjustment determination unit further determines that there exists additional space available for use based on the current status of windows 181. Then, the calculation unit 15 calculates the dynamic adjustment parameter 151 based on the current status of windows 181 and performs accordingly the adjustment of the first window 41.

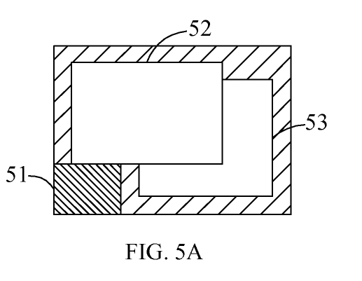

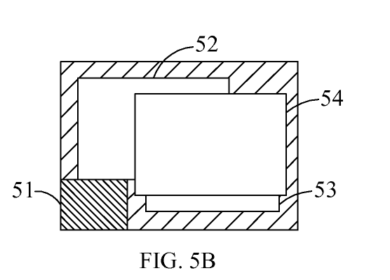

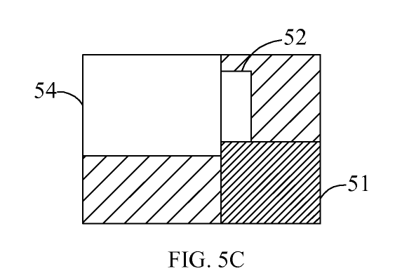

In case there are already excessively many windows opened in the window-based operating system, and thus no sufficient space exist for accommodating the automatically adjusted window 13, the system according to the present invention can perform squeeze adjustment to modify the sizes and positions of other windows, or even having them minimized or closed, thereby creating more screen space for the use by the automatically adjusted window 13. Referring now to FIG. 5, wherein a diagram showing the third embodiment of the system of automatic window adjustment and the method thereof according to the present invention is depicted. Hereunder FIG. 5 will be taken as an example for illustrating the system of automatic window adjustment according to the present invention.

In FIG. 5A, the first window 51 is the automatically adjusted window 13, the second window 52 is the active window, and the third window 53 is blocked by the second window 52. The message reception unit 12 receives the message from the operating system 18.

In FIG. 5B, the fourth window 54 is opened. Now the message reception unit 12 receives a window change message from the operating system 18. Next, the adjustment determination unit 14 determines that the first window 51 is blocked based on the window change message and the current status of windows 181 in the operating system 18. The squeeze adjustment unit 16 then generates the squeeze adjustment parameter 161 based on the current status of windows 181, and performs an adjustment of other windows in accordance with the squeeze adjustment parameter 161. Herein the second window 52 is held active and unchanged, the third window 53 is minimized in size, and the fourth window 54 is moved to upper left corner. Subsequently, the calculation unit 15 calculates the dynamic adjustment parameter 151 based on the current status of windows 181 and performs accordingly the adjustment of the first window 51.

FIG. 5C illustrates the result of the aforementioned adjustment operations, wherein the second window 52 is kept active and unchanged, the third window 53 is reduced to the minimum size, and the fourth window 54 is moved to upper left corner, while the first window 51 is adjusted by using the space acquired from the squeeze adjustment.

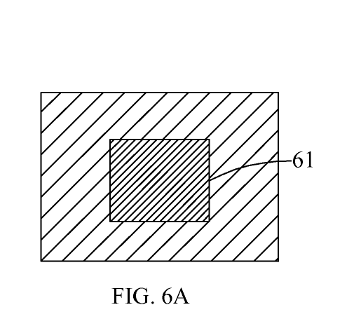

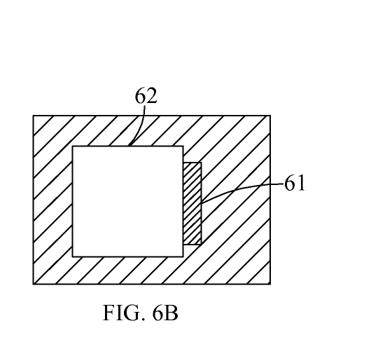

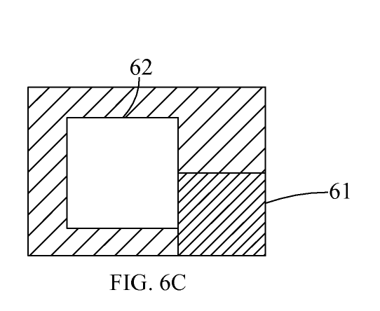

For certain types of windows, e.g., instant messaging software, the window is allowable for being temporarily blocked in case no new event occurs, until some trigger conditions (such as a new message is brought in) are satisfied, by then the window adjustment operations start. To deal with the above situation, the present invention provides the deferred adjustment mode. Referring now to FIG. 6, wherein a diagram showing the fourth embodiment of the system of automatic window adjustment and the method thereof according to the present invention is depicted. Hereunder, FIG. 6 will be taken as an example for illustrating the system of automatic window adjustment according to the present invention.

In FIG. 6A, the setting unit 11 sets the first window 61 as the automatically adjusted window 13, and also sets its mode parameter 111 as the delayed adjustment mode. The message reception unit 12 receives messages issued from the operating system 18.

In FIG. 6B, the second window 62 is opened. Then, the message reception unit 12 receives a window change message from the operating system 18. Next, the adjustment determination unit 14 determines that the first window 61 is blocked based on the window change message and the current status of windows 181 in the operating system 18. Following this, the calculation unit 15 calculates the dynamic adjustment parameter 151 based on the current status of windows 181. But since the first window 61 has been set as under the deferred adjustment mode, adjustment of the first window 61 will not be immediately performed until a certain trigger condition is satisfied, such as the first window 61 receives a new message or important contents change in the window etc. By then, the first window 61 will be adjusted in accordance with the dynamic adjustment parameter 151. The result after adjustment is shown in FIG. 6C.

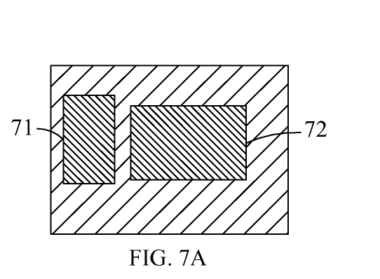

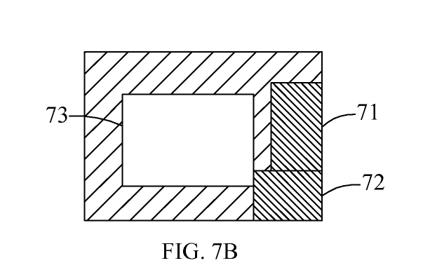

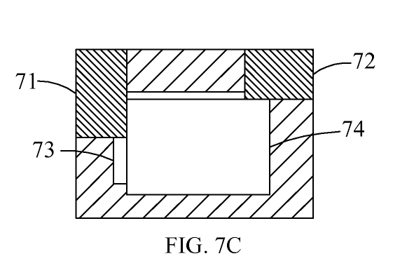

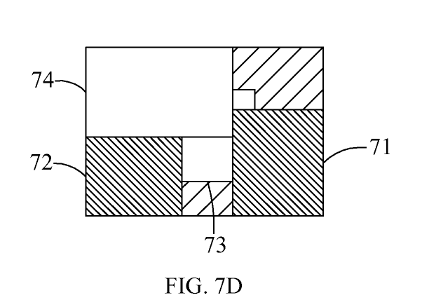

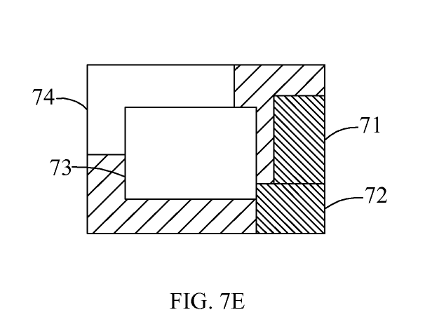

The system of automatic window adjustment according to the present invention can be not only used for one single window, but multiple windows for adjustment thereon at the same time. Refer next to FIG. 7, wherein a diagram showing the fifth embodiment of the system of automatic window adjustment and the method thereof according to the present invention is depicted. Hereunder FIG. 7 will be taken as an example for illustrating the system of automatic window adjustment according to the present invention.

In FIG. 7A, the setting unit 11 sets the first window 71 and the second window 72 as the automatically adjusted windows 13. The message reception unit 12 receives messages issued from the operating system 18.

In FIG. 7B, the third window 73 is opened and blocks the first window 71 and the second window 72. Then the message reception unit 12 receives a window change message from the operating system 18. Next, the adjustment determination unit 14 determines that the first window 71 and the second window 72 are blocked based on the window change message and the current status of windows 181 in the operating system 18. Following this, the calculation unit 15 calculates the dynamic adjustment parameter 151 based on the current status of windows 181 and performs accordingly an adjustment of the first window 71 and the second window 72.

In FIG. 7C, the fourth window 74 is opened and blocks the first window 71, the second window 72 and the third window 73. Now, the message reception unit 12 receives a window change message from the operating system 18. Next, the adjustment determination unit 14 determines that the first window 71 and the second window 72 are blocked based on the window change message and the current status of windows 181 in the operating system 18. Subsequently, the calculation unit 15 calculates and obtains the dynamic adjustment parameter 151 based on the current status of windows 181 and performs accordingly an adjustment of the first window 71 and the second window 72.

In FIG. 7D, the fourth window 74 is moved to upper left corner and blocks the first window 71, the second window 72 and the third window 73. In this case, the message reception unit 12 receives a window change message from the operating system 18. Next, the adjustment determination unit 14 determines that the first window 71 and the second window 72 are blocked based on the window change message and the current status of windows 181 in the operating system 18. Subsequently, the calculation unit 15 calculates and obtains the dynamic adjustment parameter 151 based on the current status of windows 181 and performs accordingly an adjustment of the first window 71 and the second window 72.

In FIG. 7E, the third window 73 is set to be active and blocks the first window 71, the second window 72 and the fourth window 74. At this moment the message reception unit 12 receives a window change message from the operating system 18. Next, the adjustment determination unit 14 determines that the first window 71 and the second window 72 are blocked based on the window change message and the current status of windows 181 in the operating system 18. Then, the calculation unit 15 calculates and obtains the dynamic adjustment parameter 151 based on the current status of windows 181 and performs accordingly an adjustment of the first window 71 and the second window 72.

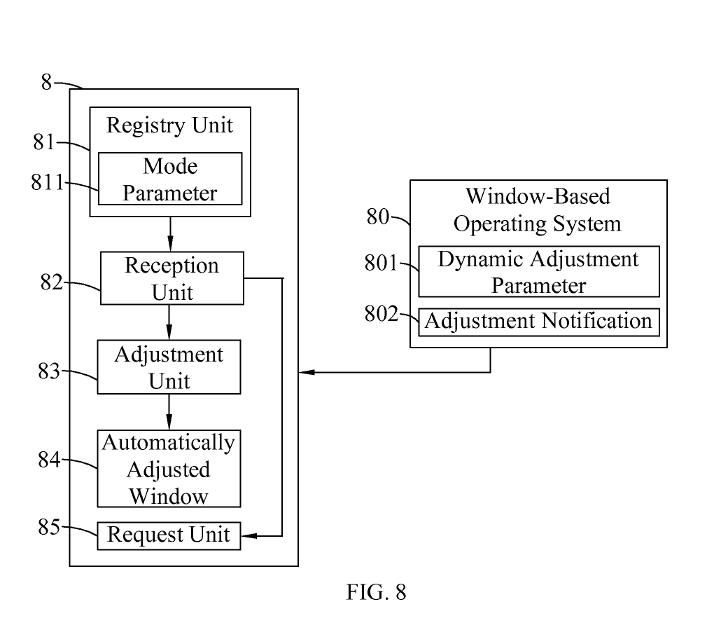

Hereunder another embodiment of the system of automatic window adjustment according to the present invention will be illustrated. Referring now to FIG. 8, wherein a diagram of the system of automatic window adjustment according to the present invention is shown. In the Figure, the window-based operating system 80 generates the dynamic adjustment parameter 801 based on the status of the window. The system 8 of automatic window adjustment comprises a registry unit 81, a reception unit 82, an adjustment unit 83, an automatically adjusted window 84 and a request unit 85. The registry unit 81 can be arranged to register the window as an automatically adjusted window 84. The reception unit 82 can be arranged to receive the dynamic adjustment parameter 801 and the adjustment notification 802. The adjustment unit 83 performs window adjustment based on the dynamic adjustment parameter 801. The automatically adjusted window 84 can be adjusted in accordance with the dynamic adjustment parameter 801 so as to prevent from being blocked by other windows. The window can become the automatically adjusted window 84 either through calling relevant program code after being opened, or by means of registering the window as the automatically adjusted window 84 via the registry unit 81. The request unit 85 requests the window-based operating system 80 to transfer the dynamic adjustment parameter 801 upon reception of the adjustment notification 802 in the reception unit 82. The registry unit 81 further comprises the mode parameter 811, which can be arranged to set the adjustment mode, thereby performing adjustment according to the mode parameter 811 during window adjustment. The mode parameter may be the immediate adjustment mode, the deferred adjustment mode or the notification mode. The immediate adjustment mode causes immediate adjustment in accordance with the dynamic adjustment parameter 801. The delayed adjustment mode starts the adjustment based on the dynamic adjustment parameter 801 only when a certain trigger condition, such as the window receives a new message or important contents change in the window etc., is satisfied. The notification mode notifies the automatically adjusted window 84 as soon as the adjustment determination result indicates the adjustment is required.

Herein the aforementioned window-based operating system 80 may be a window-based operating system enabling a function for calculating the dynamic adjustment parameter of the window, or may alternatively comprise the system 1 of automatic window adjustment (hereinafter briefly referred as the first system 1) and the operating system 18 as shown in FIG. 1. In the environment of the window-based operating system 80, independently operated software possibly exists therein which comprises the system 8 of automatic window adjustment similar to the one shown in FIG. 8 (hereinafter briefly referred as the second system 8). In the following texts, the interoperations between the first system 1 and the second system 8 will be generally described.

At first, the registry unit 81 of the second system 8 registers the window as the automatically adjusted window 84, and the setting unit 11 in the first system 1 sets the window as the automatically adjusted window 13 and sets its mode parameter 111 as the notification mode as well. In case the window needs to be adjusted, the first system 1 calculates the dynamic adjustment parameter 151 based on the status of the window, and then the first system 1 sends the dynamic adjustment parameter 151 and issues the notification indicating the window is blocked. At this time, the reception unit 82 of the second system 8 receives the dynamic adjustment parameter 151, and next the adjustment unit 83 of the second system 8 performs window adjustment based on the dynamic adjustment parameter 151.

Referring now to FIG. 6, wherein a diagram showing the fourth embodiment of the system of automatic window adjustment and the method thereof according to the present invention is depicted. Hereunder FIG. 6 will be taken as an example for illustrating the interoperations between the first system 1 and the second system 8.

In FIG. 6A, initially, the registry unit 81 of the second system 8 registers the first window 61 as the automatically adjusted window 84, and then the setting unit 11 in the first system 1 sets the first window 61 as the automatically adjusted window 13 and sets its mode parameter 111 as the notification mode as well. At this moment, the message reception unit 12 of the first system 1 receives the message issued from the operating system 18.

In FIG. 6B, the second window 62 is opened. Now the message reception unit 12 in the first system 1 receives a window change message from the operating system 18. Next, the adjustment determination unit 14 of the first system 1 determines that the first window 61 is blocked based on the window change message and the window status parameter 181 in the operating system 18. Following this, the calculation unit 15 of the first system 1 calculates the dynamic adjustment parameter 151 based on the window status parameter 181. Since the first window 61 is set to be under the notification mode, the adjustment notification 802 is sent. Following this, the reception unit 82 in the second system 8 receives the adjustment notification 802, and the request unit 85 requests the transfer of the adjustment notification 802 from the first system 1. Upon reception of the request, the first system 1 issues the dynamic adjustment parameter 801 to the second system 8, then the reception unit 82 receives the dynamic adjustment parameter 801 and the adjustment unit 83 of the second system 8 performs adjustment of the first window 61 based on the dynamic adjustment parameter 801, whose result after adjustment can be shown as FIG. 6C.

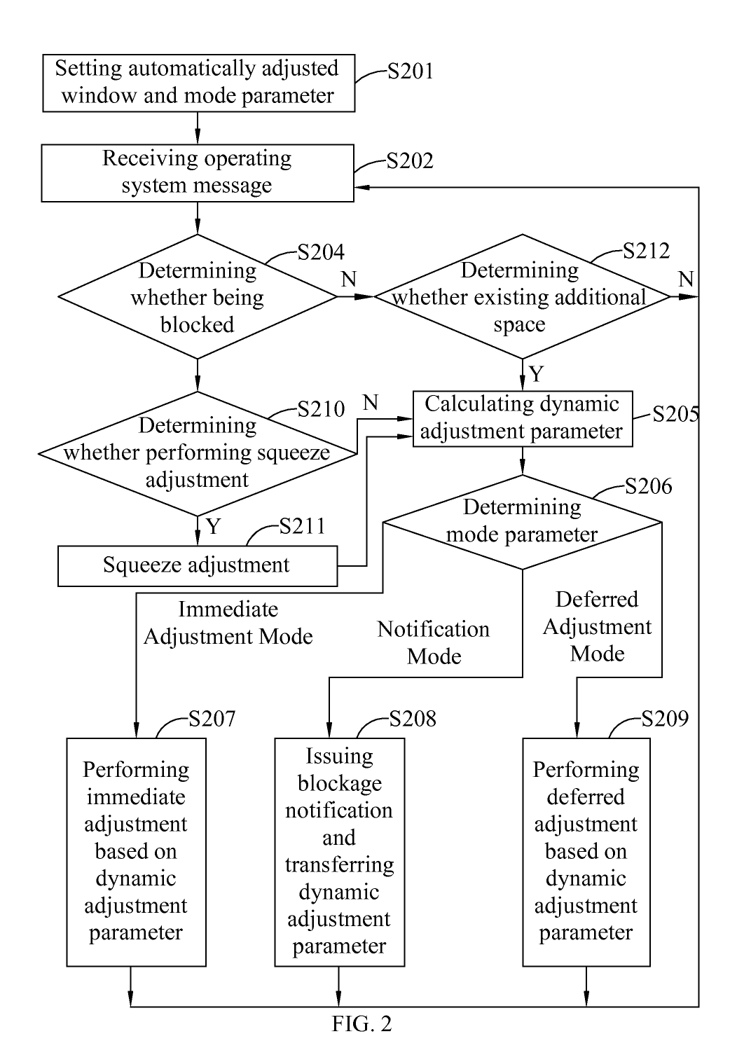

Refer subsequently to FIG. 2, wherein a flowchart of the method of automatic window adjustment according to the present invention is shown. The method of automatic window adjustment illustrated in the Figure comprises the following steps: in STEP S201, setting the automatically adjusted window and the mode parameter, in which the setting can be accomplished by the user, the operating system or the application program; in STEP S202, receiving the message sent from the operating system; in STEP S204, determining whether the automatically adjusted window is blocked; in case blocked, then performing STEP S210 for determining whether to perform squeeze adjustment; if yes, then moving to STEP S211. In STEP S211, squeeze adjustment is done based on the current status of windows which moves, reduces or closes other windows in order to acquire more usable space. Next, STEP S205 is performed. If STEP S210 determines not to perform squeeze adjustment, then moving directly to STEP S205; in STEP S205, calculating the dynamic adjustment parameter based on the window status parameter; in STEP S206, selecting corresponding adjusted mode based on the mode parameter, in which the mode parameter may be the immediate adjustment mode, the deferred adjustment mode or the notification mode. If the mode parameter is the immediate adjustment mode, then performing STEP S207 where adjustment will take place in no time based on the dynamic adjustment parameter. If the mode parameter is the deferred adjustment mode, then performing STEP S209 where adjustment will not be done right away until a certain trigger condition, such as the window receives a new message or important contents change in the window and so forth, is satisfied, by then the adjustment will be completed based on the dynamic adjustment parameter. In case the mode parameter is the notification mode, then moving toward STEP S208 where adjustment notification is sent and the notified application itself is responsible for deciding whether or how to perform adjustment.

Herein STEP S204, if determined has not being blocked, then STEP S212 is performed, therein determining whether additional space is available based on the window status parameter; if true, and then STEP S205 is performed.

Due to significant similarity in terms of practice details of the present method of automatic window adjustment according to the present invention with the one described in previous texts, illustration thereof is thus omitted for brevity.

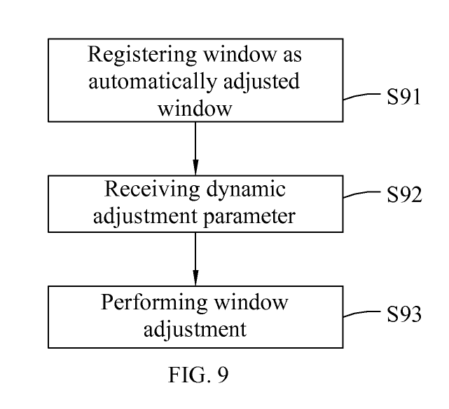

Hereunder another embodiment of the method of automatic window adjustment according to the present invention will be described. Referring now to FIG. 9, wherein a flowchart of the method of automatic window adjustment according to the present invention is shown. Herein the window-based operating system generates the dynamic adjustment parameter based on the status of windows. The method of automatic window adjustment comprises the following steps: initially, in STEP S91, registering the window as the automatically adjusted window; next, in STEP S92, receiving the dynamic adjustment parameter; then in STEP S93, performing adjustment of the window based on the dynamic adjustment parameter.

The embodiment may further comprise the following steps: at first, receiving the adjustment notification issued from the window-based operating system; then requesting the window-based operating system to send the dynamic adjustment parameter.

The embodiment may further comprise the mode parameter, which can be arranged to set the corresponding adjustment mode, thereby performing adjustment according to the mode parameter during window adjustment. The mode parameter may be the immediate adjustment mode, the deferred adjustment mode or the notification mode. The immediate adjustment mode causes immediate adjustment in accordance with the dynamic adjustment parameter; the deferred adjustment mode starts the adjustment based on the dynamic adjustment parameter only when a certain trigger condition, such as the window receives a new message or important contents change in the window and the like, is satisfied.

Herein the aforementioned window-based operating system may be a window-based operating system enabling a function for calculating the dynamic adjustment parameter of the window, or may alternatively comprise the system 1 of automatic window adjustment (hereinafter briefly referred as the first system 1) and the operating system 18 as shown in FIG. 1. In the environment of the window-based operating system 80, independently operated software possibly exists therein which comprises the method of automatic window adjustment similar to the one shown in FIG. 9. Due to significant similarity in terms of interoperations between the first system 1 and the method of automatic window adjustment of another embodiment with the one described in previous texts, illustration thereof is thus omitted for brevity.

The aforementioned illustrations are simply exemplary, rather than being restrictive. All effectively equivalent modifications or changes made thereto without departing from the spirit and scope of the present invention are deemed to be included in the claims set forth hereunder.

1. A system of automatic window adjustment applicable to an electronic device running a window-based operating system, the window-based operating system generating a message based on a user's operation conditions and having a plurality of window status parameters, the system of automatic window adjustment comprising:
a window;
a message reception means or unit arranged to receive the message;
an adjustment determination means or unit determining whether adjustment of the window is required based on the message and the plurality of window status parameters, and generating an adjustment determination result; and
a calculation means or unit calculating a dynamic adjustment parameter in accordance with the plurality of window status parameters and performing window adjustment based on the dynamic adjustment parameter while the adjustment determination result indicates adjustment is required.

2. The system of automatic window adjustment according to claim 1, wherein the adjustment determination unit determines whether the window is blocked based on the plurality of window status parameters; and wherein, if the window is determined as being blocked, then the adjustment determination result indicates the adjustment is required.

3. The system of automatic window adjustment according to claim 2, wherein the message is a window open message, a window close message, a window move message, a window resize message, a window active status change message, a window hide message, a window show message, a screen resolution change message or a screen available space change message.

4. The system of automatic window adjustment according to claim 2, wherein the adjustment determination unit further determines whether additional space is available for use by the window based on the plurality of window status parameters, and wherein if additional space is available, then the adjustment determination result indicating the adjustment is required.

5. The system of automatic window adjustment according to claim 2, further comprising:
a squeeze adjustment means or unit generating a squeeze adjustment parameter based on the plurality of window status parameters, and accordingly moving or resizing at least one other window so as to acquire more space for use by the window.

6. The system of automatic window adjustment according to claim 2, further comprising:
a setting means or unit setting an automatically adjusted window.

7. The system of automatic window adjustment according to claim 6, wherein the setting unit further comprises a profile, and wherein the window is automatically selected as the automatically adjusted window when the window matches the profile.

8. The system of automatic window adjustment according to claim 2, further comprising:
a mode parameter indicating an adjustment mode of the window and performing the adjustment based on the mode parameter.

9. The system of automatic window adjustment according to claim 8, wherein the mode parameter is an immediate adjustment mode causing immediate adjustment of the window based on the dynamic adjustment parameter as soon as the dynamic adjustment parameter is calculated.

10. The system of automatic window adjustment according to claim 8, wherein the mode parameter is a notification mode causing notification to the window in case the adjustment determination result indicates that the adjustment is required.

11. The system of automatic window adjustment according to claim 8, wherein the mode parameter is a deferred adjustment mode deferring the adjustment of the window based on the dynamic adjustment parameter until a trigger condition is satisfied.

12. A system of automatic window adjustment applicable to a window-based operating system, the window-based operating system generating a dynamic adjustment parameter based on status of at least one other window for adjusting a window, the system of automatic window adjustment comprising:
a window;
a reception means or unit receiving the dynamic adjustment parameter; and
an adjustment means or unit performing an adjustment of the window, an adjustment of the other window, or adjustments of both the window and the other window based on the dynamic adjustment parameter.

13. The system of automatic window adjustment according to claim 12, further comprising:
a request means or unit requesting the window-based operating system to issue the dynamic adjustment parameter upon reception of an adjustment notification at the reception unit.

14. The system of automatic window adjustment according to claim 12, further comprising:
a registry means or unit arranged to register the window as an automatically adjusted window.

15. The system of automatic window adjustment according to claim 12, further comprising:
a mode parameter indicating an adjustment mode of the window and performing the adjustment based on the mode parameter.

16. The system of automatic window adjustment according to claim 15, wherein the mode parameter is an immediate adjustment mode causing immediate adjustment of the window based on the dynamic adjustment parameter as soon as the dynamic adjustment parameter is calculated.

17. The system of automatic window adjustment according to claim 15, wherein the mode parameter is a notification mode causing notification to the window in case the adjustment determination result indicates that the adjustment is required.

18. The system of automatic window adjustment according to claim 15, wherein the mode parameter is a deferred adjustment mode deferring the adjustment of the window based on the dynamic adjustment parameter until a trigger condition is satisfied.

19. A method of automatic window adjustment applicable to a window-based operating system generating a message according to a user's operation conditions and having a plurality of window status parameters, the method of automatic window adjustment comprising the following steps:
receiving the message;
determining whether adjustment of the window is required based on the message and the plurality of window status parameters
calculating, if the adjustment of the window is determined as being required, a dynamic adjustment parameter in accordance with the plurality of window status parameters; and
performing the adjustment of the window based on the dynamic adjustment parameter.

20. The method of automatic window adjustment according to claim 19, wherein the step of determining whether window adjustment is required comprises the following steps:
determining whether the window is blocked based on the plurality of window status parameters; and
indicating the adjustment of the window as being required while the window is determined as being blocked.

21. The method of automatic window adjustment according to claim 20, wherein the message is a window open message, a window close message, a window move message, a window resize message, a window active status change message, a window hide message, a window show message, a screen resolution change message or a screen available space change message.

22. The method of automatic window adjustment according to claim 20, wherein the step of determining whether the window adjustment is required further comprises:
determining whether additional space is available for use by the window in accordance with the plurality of window status parameters, and if additional space is available, then determining the adjustment is required.

23. The method of automatic window adjustment according to claim 20, further comprising the following steps:
determining whether a squeeze adjustment is required;
generating a squeeze adjustment parameter based on the plurality of window status parameters in case the squeeze adjustment is required; and
moving or resizing at least one other window based on the squeeze adjustment parameter so as to acquire more space for use by the window.

24. The method of automatic window adjustment according to claim 20, further comprising the step of:
setting the window as an automatically adjusted window.

25. The method of automatic window adjustment according to claim 24, further comprising the step of:
setting a profile, and the window being automatically selected as the automatically adjusted window while the window matching the profile.

26. The method of automatic window adjustment according to claim 20, further comprising the following step:
setting a mode parameter indicating an adjustment mode of the window, and performing adjustment according to the mode parameter.

27. The method of automatic window adjustment according to claim 26, wherein the mode parameter is an immediate adjustment mode causing immediate adjustment of the window based on the dynamic adjustment parameter as soon as the dynamic adjustment parameter is calculated.

28. The method of automatic window adjustment according to claim 26, wherein the mode parameter is a notification mode causing notification to the window in case the adjustment determination result indicates that the adjustment is required.

29. The method of automatic window adjustment according to claim 26, wherein the mode parameter is a deferred adjustment mode deferring the adjustment of the window based on the dynamic adjustment parameter until a trigger condition is satisfied.

30. A method of automatic window adjustment applicable to a window-based operating system, the window-based operating system generating a dynamic adjustment parameter based on status of at least one other window for adjusting a window, the method of automatic window adjustment comprising the following steps:
receiving the dynamic adjustment parameter; and
performing an adjustment of the window, an adjustment of the other window and adjustments of both the window and the other window based on the dynamic adjustment parameter.

31. The method of automatic window adjustment according to claim 30, further comprising the following steps:
receiving an adjustment notification; and
requesting the window-based operating system to send the dynamic adjustment parameter.

32. The method of automatic window adjustment according to claim 30, further comprising a step of:
registering the window as an automatically adjusted window.

33. The method of automatic window adjustment according to claim 30, further comprising the following step:
setting a mode parameter indicating an adjustment mode of the window, and performing the adjustment according to the mode parameter.

34. The method of automatic window adjustment according to claim 33, wherein the mode parameter is an immediate adjustment mode causing immediate adjustment of the window based on the dynamic adjustment parameter.

35. The method of automatic window adjustment according to claim 33, wherein the mode parameter is a notification mode causing notification to the window in case the adjustment determination result indicates that the adjustment is required.

36. The method of automatic window adjustment according to claim 33, wherein the mode parameter is a deferred adjustment mode deferring the adjustment of the window based on the dynamic adjustment parameter until a trigger condition is satisfied.
